(19) United States
(12) Patent Application Publication
(10) Pub. No.: US 2014/0158490 A1
(43) Pub. Date: Jun. 12, 2014

(54) RETENTION DEVICE HAVING AN OVERLOAD PROTECTION COUPLING FOR THE RETENTION OF AT LEAST ONE TOOL ELEMENT IN A VEHICLE BODY MANUFACTURING SYSTEM

(71) Applicant: Thyssenkrupp System Engineering GmbH, Heilbronn (DE)

(72) Inventors: Helmut KASPER, Wadern (DE); Tino Kipping, Schmelz (DE)

(21) Appl. No.: 13/938,425

(22) Filed: Jul. 10, 2013

Related U.S. Application Data
(63) Continuation of application No. PCT/EP2012/000026, filed on Jan. 4, 2012.

(30) Foreign Application Priority Data
Jan. 10, 2011 (DE) 10 2011 008 194.1

(51) Int. Cl. F16D 7/00

(52) U.S. Cl. CPC F16D 7/00
USPC 192/55.1

(57) ABSTRACT

Retention device for the retention of at least one part, which is to be retained, in a vehicle body manufacturing system, has an overload protection coupling, and the overload protection coupling has a first and a second coupling unit. One of the first and second coupling units has a connecting element which can be releasably coupled to the other one of the coupling units. The other coupling unit has at least one clamping element to which an element for generating a clamping force which creates a connection between the clamping element and the connecting element is assigned in such a way that the connection can be automatically released by a release force which overcomes the clamping force.

### CROSS-REFERENCE TO RELATED APPLICATIONS

This application is a continuation of application no. PCT/EP2012/000026, filed Jan. 4, 2012, which claims the priority of German Application No. 10 2011 008 194.1, filed Jan. 10, 2011, and each of which is incorporated herein by reference.

### FIELD OF THE INVENTION

The present invention relates to a retention device for the retention of at least one part to be retained in a vehicle body manufacturing system, having an overload protection coupling, wherein the overload protection coupling has a first and a second coupling unit which are releasably connected together.

### BACKGROUND OF THE INVENTION

Such retention devices are generally known and are used in vehicle body manufacturing systems, in particular for the retention and automatic control of tools, which serve for machining the vehicle body directly, such as for example welding devices, or which are provided for gripping chassis parts of the vehicle body, for example brackets. There is the risk that the retention devices are damaged by incorrect operation or control of said retention device or when receiving faulty tools or components. This may occur, for example, as a result of the tools or components which have been actuated colliding with other tools, components or the like. The repairs to the retention devices, on the one hand, are cost-intensive and, on the other hand, cause the entire vehicle body manufacturing system to be brought to a standstill.

In order to solve this problem, the publication EP 1 736 274 A2 proposes a device for constructing a vehicle chassis in a welding station of a vehicle body manufacturing system, which for receiving chassis parts comprises a mounting bracket which is fastened to a retention device via a separate central fastening pin. The central fastening pin has a weakened region functioning as a predetermined rupture point with a reduced diameter which ruptures in the presence of a corresponding mechanical release force and thus prevents damage to the retention device. The central fastening pin thus functions as an overload protection coupling. After the rupture of the fastening pin, the ruptured fastening pin is replaced by a new pin to recreate the coupling between the mounting bracket and the retention device.

### OBJECTS AND SUMMARY OF THE INVENTION

It is an object of the present invention to provide a retention device having an overload protection coupling for the retention of at least one part to be retained in a vehicle body manufacturing system, which ensures a decoupling between the retention device and the tool element in the presence of a defined release force, wherein at the same time it is possible to recreate the coupling in a simple and time-saving manner and also the release force required for the decoupling is able to be adjusted in a flexible and accurate manner.

This object is achieved by a retention device for the retention of at least one part to be retained in a vehicle body manufacturing system, having an overload protection coupling, wherein the overload protection coupling has a first and a second coupling unit, wherein one of the first and second coupling units has a connecting element which is able to be releasably coupled to the other coupling unit and wherein the other coupling unit has at least one clamping element, to which an element is associated for producing a clamping force which creates a connection between the clamping element and the connecting element, such that the connection is able to be automatically released by a release force which overcomes the clamping force.

The device according to the invention has the advantage relative to the prior art that a decoupling between the first and the second coupling units does not take place by the rupture of a fastening pin but instead takes place by overcoming the clamping force, whereby the connecting element comes out of engagement with the clamping elements. Advantageously, it is thus not necessary to replace a faulty part in order to recreate the coupling between the first and second coupling units, whereby the length of time required for interrupting the operation of the vehicle body manufacturing system is considerably reduced.

Advantageous embodiments and developments of the invention may be derived from the sub-claims and the description, with reference to the drawings.

According to a further development of the present invention, it is provided that the at least one clamping element is resiliently pretensioned by means of the element in the direction of the connecting element, wherein the element preferably comprises an energy storage device for subjecting the at least one clamping element to a force in the direction of the connecting element and wherein particularly preferably a device is provided for adjusting the force of the energy storage device acting in the direction of the connecting element. Advantageously, the clamping element is resiliently pretensioned in the direction of the connecting element by means of the energy storage device which, for example, comprises a compression spring, whereby the clamping force is produced between the clamping element and the connecting element. The retention force of the connection depends, amongst other things, on the pretensioning of the clamping element in the direction of the connecting element, which is preferably able to be adjusted by adjusting the force acting from the energy storage device on the clamping element. If the force acting between the first and second coupling units exceeds a specific release value, the resiliently pretensioned clamping element is pushed back counter to the pretensioning and the connecting element is released. Subsequently, a coupling may be recreated between the first and second coupling units in a simple manner, by the connecting element being arranged in its initial position relative to the clamping element by a corresponding force and, in particular, once again by overcoming the pretensioning. A further advantage of the retention device according to the invention is that slight deflections of the part to be retained relative to the retention device do not necessarily lead to a decoupling. Instead, in the event of slight deflections, the connecting element is preferably able to be sprung back into its initial position. The clamping elements comprise, for example, clamping pins, clamping balls or the like.

According to a further development of the present invention, it is provided that the second coupling unit has at least three clamping elements arranged radially in a main plane, said clamping elements being arranged substantially rotationally symmetrically around the connecting element aligned perpendicular to the main plane. Advantageously, the release force is virtually the same for all of the force components acting on the part to be retained parallel to the main plane, due to the rotationally symmetrical arrangement of the at least three clamping elements. The connecting element which preferably comprises a connecting pin, is preferably exclusively retained non-positively and positively with the second coupling unit relative to tilting movements in a plane perpendicular to the main plane, by the three clamping elements which, for example, are configured as clamping pins, so that slight deflections do not immediately lead to a decoupling of the overload protection coupling. Moreover, by means of the rotationally symmetrically arranged clamping elements accurate positioning of the connecting element is possible in the center of the clamping elements which are arranged in a star-shaped manner. Naturally, for the person skilled in the art, the number of clamping elements may optionally also be greater than three and, in particular, equal to four, five, six or seven. By a greater number of clamping elements, for example, a considerable increase in the release force may be achieved. When using just three clamping elements, the three clamping elements may be arranged offset to one another in the main plane, preferably in each case by 120 degrees, so that the connecting pin is centered merely by the three clamping elements. When using more than three clamping elements, the clamping elements are preferably arranged such that in each case the same angles are formed between adjacent clamping elements in the main plane around the connecting element, in order to ensure a centering of the connecting element.

According to a further development of the present invention, it is provided that the connecting pin has a cross-sectional alteration in a coupling region, wherein the at least one clamping element in the coupling region acts positively and/or non-positively on the connecting element. The cross-sectional alteration in the coupling region results in the connecting element having a chamfer along its longitudinal extent, whereby in the coupled state the connection between the first and second coupling units optionally exclusively comprises a positive connection between the connecting element and the clamping elements or alternatively a non-positive/positive connection if the clamping elements also press onto the connecting element in the initial position and thus produce a frictional connection. In both cases, however, during the decoupling process, the clamping force has to be overcome either by overcoming the friction and/or by moving the clamping elements counter to the pretensioning thereof, if a region of the connecting element having a greater cross section has to pass the clamping elements. Preferably, the at least one clamping element in each case has a tapering point on a side facing the connecting element, which particularly preferably acts on the coupling region. If the connecting element is fixedly connected to the first coupling unit, the cross section of the connecting element is altered in the coupling region, in particular such that the cross section becomes greater in the direction of the second coupling unit. Similarly, the cross section of the connecting element in the coupling region in the direction of the first coupling unit becomes greater if the connecting element is fixedly connected to the second coupling unit. In this manner, it is ensured that by the non-positive connection between the clamping elements, in particular the tips of the clamping elements, and the coupling region a tensile force is exerted on the connecting element in the coupling direction. For the decoupling, a greater cross section of the connecting element has to pass the clamping elements, whereby the clamping elements are pressed radially outwardly counter to the pretensioning thereof. The coupling region accordingly also serves as tolerance and clearance compensation between the first and second coupling units. Preferably, the connecting element comprises a connecting pin with a spherical head, the tip of at least one clamping element acting on the spherical surface thereof.

According to a further development of the present invention, it is provided that for adjusting the release force the spacing between the coupling region, in particular the spherical head and the at least one clamping element, is able to be adjusted in a direction perpendicular to the main plane.

By displacing the coupling region along the longitudinal extent of the connecting element, the cross section of the coupling region is altered relative to the at least one clamping element, so that the release force is modified. Preferably, the at least one clamping element comprises an external thread which, for producing the fixed connection to the first or second coupling unit, engages in an internal thread of the first or second coupling unit, so that by rotating the connecting element about its own axis, the relative position perpendicular to the main plane between the coupling region and the at least one clamping element and thus the release force are able to be adjusted.

According to a further development of the present invention, it is provided that the first coupling unit has a first contact surface parallel to the main plane and the second coupling unit has a second contact surface substantially parallel to the first contact surface, wherein the first contact surface bears against the second contact surface. Advantageously, the first and second contact surfaces serve as mutual bearing surfaces for absorbing forces acting at right angles to the main plane, which are not intended to lead to a decoupling between the first and second coupling unit. Moreover, the first and second contact surfaces serve as alignment aids, as the first and second contact surfaces are always aligned plane-parallel to one another, at least in the initial position. For the relative positioning of the first and second coupling units along the main plane, one of the two coupling units preferably has at least one coupling element, whilst the other of the two coupling units has at least one complementary counter-coupling element, wherein the coupling element and the counter-coupling element engage in one another in the coupled position such that a relative displacement between the first and second coupling units parallel to the main plane is prevented. The coupling element preferably comprises a coupling pin which engages perpendicular to the main plane positively in a counter coupling element configured as a receiver opening. The coupling pins thus positively engage exclusively in the receiver openings, so that a relative movement between the first and second coupling units is not hindered in a direction perpendicular to the main plane by the coupling pins, but in the vertical direction a fixing takes place exclusively by the cooperation of the connecting element to the at least one clamping element. In this manner it is ensured that, in the event of a tilting movement of the part to be retained, the first and the second coupling units may also be effectively decoupled relative to the retention device, when the release force is exceeded during the tilting movement. Preferably, three coupling elements are arranged in the main plane antisymmetrically, i.e. not rotationally symmetrically around the connecting element. In this manner, the coupling element and the counter-coupling element function at the same time as anti-twist protection, if the first and second coupling units are coupled together. Alternatively, however, it is also conceivable that the three coupling elements are arranged substantially between the clamping elements and/or in the main plane, in each case offset relative to one another by 120 degrees.

According to a embodiment of the present invention, it is provided that the second coupling unit has a through-opening, wherein the connecting element has a wall extending along an edge region of the through-opening which has at least one latching opening with which the at least one clamping element interacts to produce the clamping force effecting the connection between the clamping element and the connecting element, such that the connection is able to be automatically released by a release force overcoming the clamping force. Advantageously, an automatic release of the connection is effected when the release force exceeds the clamping force as in this case the at least one clamping element is moved counter to the clamping force and slips out of the latching opening. The non-positive and positive fixing between the first and second coupling units is then released. Preferably, the wall has a plurality of latching openings and the retention device has a plurality of clamping elements, wherein in each case a clamping element cooperates with a latching opening. The latching openings and clamping elements are preferably uniformly distributed in the peripheral direction of the through-opening, so that the connecting element is preferably fixed centrally within the wall.

According to a embodiment of the present invention, it is provided that the maximum external diameter of the first coupling unit is smaller than the maximum internal diameter of the through-opening. This has the advantage that the connection is released even in the case of release forces exceeding the clamping force, which act perpendicular to the main plane. A force which acts perpendicular to the main plane on the part to be retained leads to a release of the overload protection coupling when a specific threshold is exceeded. Such forces may, for example, occur when a robot guiding the retention device inadvertently drives the retention device vertically onto an obstruction. The first coupling unit is then pressed through the through-opening of the second coupling unit. Alternatively, it is also conceivable that a tensile force acts on the part to be retained, via which the first coupling unit is pulled out of the second coupling unit in the direction of the part to be retained. Such a tensile force may occur, for example, when the part to be retained has inadvertently been caught on an obstruction and a robot guiding the retention device pulls back the retention device from the obstruction. For the person skilled in the art, it goes without saying that the retention device is preferably naturally also able to be released by such forces which act on the part to be retained with a force component acting parallel to the main plane and as a result the clamping force is overcome. In this case, the first coupling unit is, in particular, levered out of the second coupling unit.

According to a embodiment of the present invention, it is provided that the first coupling unit is at least partially enclosed along the main plane by the wall, wherein the wall is bulged in a convex manner on a side facing the first coupling unit and/or wherein the first coupling unit is bulged in a convex manner on a side facing the wall. Preferably, the convex bulged surfaces permit a pivoting movement of the first coupling unit relative to the second coupling unit, without there being the risk that the first and the second coupling units jam relative to one another. The wall is preferably configured as a collar which protrudes from the second coupling unit in the edge region of the through-opening in a direction perpendicular to the main plane. The first coupling unit is preferably of annular configuration. This has the advantage that adjusting screws may be arranged in an accessible manner in an internal annular opening of the ring, said adjusting screws being preferably provided for adjusting the element which spring-loads the clamping elements, which is preferably a compression spring. Thus an adaptation and/or readjustment of the clamping force is possible in a simple manner.

According to a embodiment of the present invention, it is provided that the clamping element on a side facing the connecting element has a contact surface configured as a spherical surface, which is subjected to force by means of the element in the direction of the latching opening, wherein the contact surface protrudes at least partially into the latching opening and wherein the clamping element is preferably configured as a ball, the maximum external diameter thereof being greater than the maximum internal diameter of the latching opening. Advantageously, the first coupling unit is thus positively and non-positively fixed relative to a movement along the main plane and relative to a movement perpendicular to the main plane. After releasing the overload protection coupling, the connection may be recreated in a simple manner by rearranging the first coupling unit inside the second coupling unit.

A further subject of the present invention is the use of the retention device for the retention of a part to be retained in a vehicle body manufacturing system, in particular of a vehicle body production line.

Further details, features and advantages of the invention are revealed from the drawings and the following description of embodiments with reference to the drawings. In this case, the drawings merely illustrate exemplary embodiments of the invention which do not limit the essential idea of the invention.

### BRIEF DESCRIPTION OF THE DRAWINGS

FIG. 1 shows a schematic side view of a retention device according to an exemplary first embodiment of the present invention.

FIG. 2a shows a schematic view of a second coupling unit of a retention device according to the exemplary first embodiment of the present invention.

FIG. 2b shows a schematic view of a schematic side view of a first coupling unit of a retention device according to the exemplary first embodiment of the present invention.

FIG. 3 shows a schematic side view of a retention device according to an exemplary second embodiment of the present invention.

FIG. 4 shows a schematic side view of a second coupling unit of a retention device according to the exemplary second embodiment of the present invention.

FIG. 5a shows a schematic view of a retention device according to an exemplary third embodiment of the present invention.

FIG. 5b shows a schematic view of a retention device according to an exemplary third embodiment of the present invention.

FIG. 5c shows a schematic view of a retention device according to an exemplary third embodiment of the present invention.

FIG. 6a shows a schematic view of a retention device according to an exemplary fourth embodiment of the present invention.

FIG. 6b shows a schematic view of a retention device according to an exemplary fourth embodiment of the present invention.

FIG. 7a shows a schematic view of a retention device according to an exemplary fifth embodiment of the present invention.

FIG. 7b shows a schematic view of a retention device according to an exemplary fifth embodiment of the present invention.

FIG. 7c shows a schematic view of a retention device according to an exemplary fifth embodiment of the present invention.

FIG. 7d shows a schematic view of a retention device according to an exemplary fifth embodiment of the present invention.

FIG. 7e shows a schematic view of a retention device according to an exemplary fifth embodiment of the present invention.

### DETAILED DESCRIPTION OF THE INVENTION

In the various Figs., the same parts are always provided with the same reference numerals and thus generally also in each case only cited and/or mentioned once.

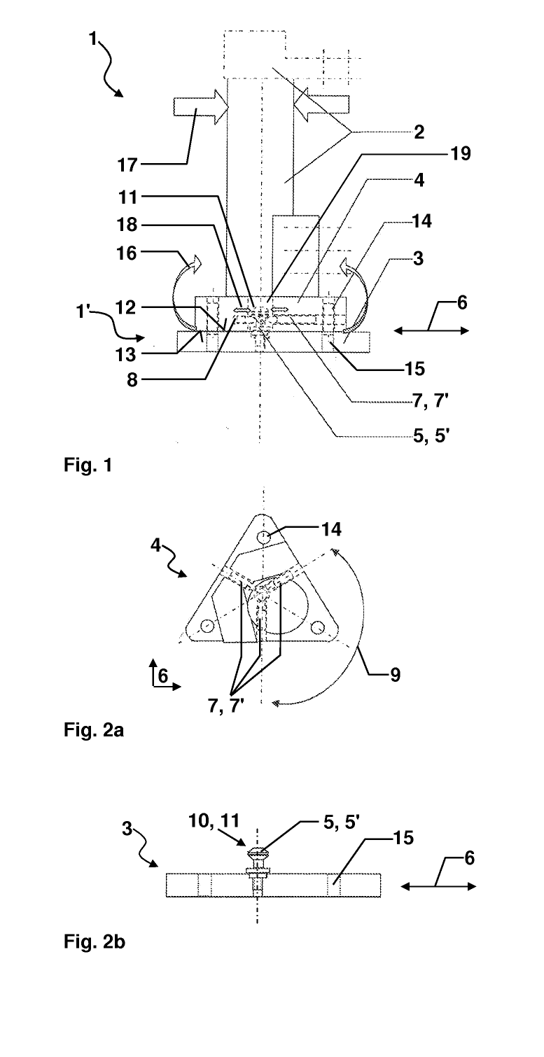

In FIG. 1, a schematic side view of a retention device 1 is shown according to an exemplary first embodiment of the present invention. The retention device 1 has an overload protection coupling 1′ for the retention of at least one part 2 to be retained, said overload protection coupling having a first coupling unit 3 and a second coupling unit 4. The overload protection coupling is provided during normal operation to ensure a coupling between the first and second coupling units 3, 4 and to release the coupling automatically in the event of a torque 16 acting between the first and second coupling units 3, 4 which exceeds a defined limit value (overload). In FIG. 1, the retention device 1 is illustrated in a state in which the first and second coupling units, 3, 4 are coupled together. The first coupling unit 3 is, for example, fixedly connected to a retention plate, not shown, or an actuator arm not shown, whilst the second coupling unit 4 is configured to retain the part 2 to be retained. In the present example, the part 2 to be retained comprises by way of example a bracket for receiving tools and/or vehicle body components (only indicated schematically). The retention device 1 is provided for use in the vehicle body manufacturing system in which, by means of the bracket, tools are retained for machining the vehicle body or chassis parts for constructing a vehicle body.

The first coupling unit 3 comprises a connecting element 5′ in the form of a connecting pin via which the first coupling unit 3 is able to be releasably coupled to the second coupling unit 5′. The connecting pin 5′ protrudes from the first coupling unit 3 perpendicular to a main plane 6 in the direction of the second coupling unit 5′ and protrudes into a recess 19 configured in the second coupling unit 4. At its end facing the second coupling unit 5′, a spherical head 11 is formed which defines a coupling region 10. The second coupling unit 4 has three clamping elements 7 in the form of clamping pins 7′ which are arranged in a star-shaped manner in the main plane 6. The clamping pins 7′ are aligned substantially rotationally symmetrically in the main plane 6 and in each case aligned in the radial direction about the connecting pin 5′ aligned perpendicular to the main plane 6. Each of the clamping pins 7′ has a tapered tip at its end facing the connecting pin 5′. The clamping pins 7′ are also displaceably mounted in the radial direction (displaceability 18 indicated in FIG. 1 by arrows) and resiliently pretensioned in the direction of the connecting pin 5′ by means of an element 8 formed as an energy storage unit (in the present case a compression spring). The tips are thus pressed in a non-positive and positive manner onto the coupling region 10 and, in particular, onto the spherical surface of the spherical head 11 of the connecting pin 5′. In this manner, a connection is made between the clamping pins 7′ and the connecting pin 5′. In the present example, the connection comprises a non-positive/positive connection. The tips are in this case subjected to a force on a region of the spherical head 11, the cross section thereof increasing in the direction of the second coupling unit 4. As a result, a tensile force acting perpendicular to the main plane 6 is produced on the connecting pin 5′ in the direction of the second coupling element 4 and/or a tensile force acting perpendicular to the main plane 6 on the clamping pins 7′ in the direction of the first coupling element 3. A first contact surface 12 of the first coupling unit 3 parallel to the main plane 6 and a second contact surface 13 of the second coupling unit 4 also parallel to the main plane 6 are thus pressed together. In the coupled state, the connecting pin 5′ preferably protrudes perpendicular to the main plane 6 into the recess 19 of the second coupling unit 4, wherein the connecting pin 5′ in the region of the recess 19 is exclusively retained non-positively by the three clamping pins 7′. A further positive connection between the wall of the recess 19 and the connecting pin 5′ is not provided so that the connecting pin 5′ is able to be deflected by slight deflections parallel to the main plane 6.

Moreover, the second coupling unit 4 has three coupling elements aligned perpendicular to the main plane 6 in the form of coupling pins 14 which engage in corresponding complementary counter-coupling elements formed in the first coupling unit 3, in the form of receiver openings 15, in order to establish a relative position between the first and second coupling units 3, 4 parallel to the main plane 6. The coupling pins 14 engage in this case—as visible in FIG. 1—only to a small extent in the receiver openings 15 in order to counteract as little as possible a tilting movement of the second coupling unit 4 relative to the second coupling unit 3.

If, due to an operational or programming error, the part 2 to be retained collides with other components, tools or brackets in the vehicle body manufacturing system, a deflection force 17 parallel to the main plane 6 acts on the part 2 to be retained. This deflection force 17 leads to a torque 16 acting on the second coupling element 4, due to the lever arm of the part 2 to be retained, as well as the coupling between the first and second coupling units 3, 4, whereby a force is produced on the connecting pin 5′ which counteracts the tensile force originating from the clamping pins 7′. The connecting pin 5′ is pulled out of the region of the clamping pins 7′, wherein the clamping pins 7′ as a result are pushed apart in the radial direction counter to the resilient pretensioning thereof. If the force exceeds a defined release value the clamping pins 7′ are forced apart to such an extent that the spherical head 11 is able to slip through between the tips of the clamping pins 7′ and the connecting pin 5′ comes out of engagement with the clamping pins 7′. The non-positive connection between the first and second coupling units 3, 4 is thus released to avoid damage to the retention device or the part 2 to be retained. In other words: the connecting pin 5′ is released from engagement with the clamping pins 7′ in the event of overload. After decoupling, the coupling between the first coupling unit 3 and the second coupling unit 4 may be recreated in a simple manner, by the second coupling unit 4 being pressed onto the first coupling unit 3 such that the spherical head 11 of the connecting pin 5′ is again engaged into the clamping pins 5′ in the manner of a snap connection. If the deflection force 17 has not been sufficient for decoupling, the second coupling unit 4 is pivoted relative to the first coupling unit 3 only by a relatively small angle and automatically springs back into its initial position as soon as the deflection force 17 is correspondingly reduced.

The minimum release force 17 required for the decoupling may optionally be adjusted in two different ways. Firstly, it is conceivable that the resilient pretensioning of the clamping pins 7′ is in each case able to be adjusted in the direction of the connecting pin 5′. To this end, the tension of a spiral spring is adjusted, for example by means of a clamping screw, said spiral spring in each case being arranged at one end of the clamping pins 7′ remote from the connecting pin 5′ and spring-loading the clamping pins 7′ in each case in the direction of the connecting pin 5′. Alternatively, it is conceivable that the connecting pin 5′ has an external thread on its shaft end facing the first coupling unit 3, which is screwed into a corresponding counterthread in the body of the first coupling unit 3. The spacing between the spherical head 11 and the first contact surface 12 may be adjusted by rotating the connecting pin 5′ relative to the remaining first coupling element 3. As a result, the relative position between the spherical head 11 and the tips 8 of the clamping pins 7′ is altered such that the tips act on different regions of the spherical surface and thus the minimum force required for the release is altered. If the tips act, for example, on the region of the spherical surface with the greatest circumference (equator region), the required release force 17 is minimal. If, however, the tips act exactly beneath the spherical head 11 in the transition region between the shaft and the spherical head 11, the required release force 17 is at a maximum.

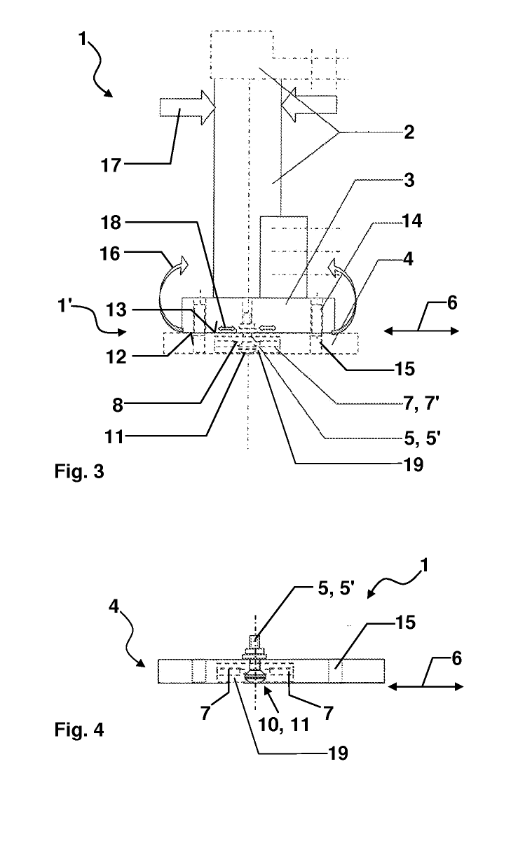

In FIGS. 2a and 2b, a schematic view of a second coupling unit 4 and a schematic side view of a first coupling unit 3 are shown, in each case of a retention device 1 according to the exemplary first embodiment of the present invention. In FIG. 2a, the rotationally symmetrical and radial arrangement of the three clamping pins 7′ may be seen, which in each case are arranged offset to one another at an angle 9 of 120 degrees. Between two adjacent clamping pins 7′ in each case a coupling pin 14 is arranged so that the three coupling pins 14 also are arranged rotationally symmetrically about the connecting pin 5′, not shown. The rotationally symmetrical construction of the second coupling unit 4 in the main plane 6 ensures that the release force for decoupling is substantially the same for all deflection forces 17 acting on the tool element 2 parallel to the main plane 6. At the same time, a centering of the connecting pin 5′ and thus a relatively accurate positioning of the tool element 2 relative to the retention device 1 is achieved. In FIG. 2b, a detailed view of the first coupling unit 3 is illustrated, in which the connecting pin 5′ and, in particular, the spherical head 11 of the connecting pin 5′ may be clearly seen.

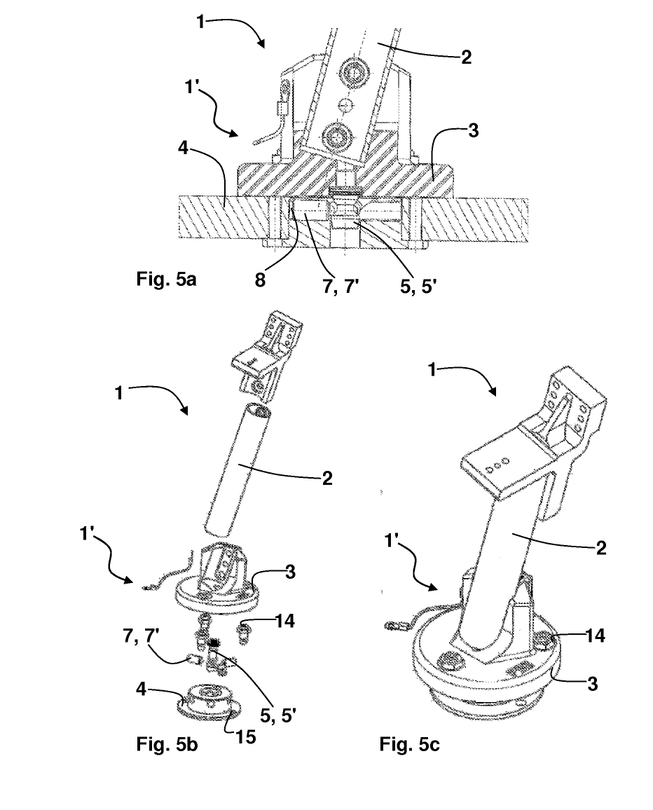

In FIG. 3, a schematic side view of a retention device 1 according to an exemplary second embodiment of the present invention is shown, wherein the second embodiment is substantially the same as the first embodiment illustrated in FIG. 1, wherein in the second embodiment the first coupling unit 3 is provided for receiving the part 2 to be retained and the second coupling unit 4, for example, is fixedly connected to a retention plate, not illustrated, or an actuator arm, not illustrated. The connecting pin 5′ is accordingly connected via the first coupling unit 3 to the tool element 2, whilst the clamping pins 7′ are connected via the second coupling unit 4 to the retention plate or the actuator arm. The second coupling element 4 has a central recess 19 and is preferably of annular configuration, wherein in the coupled state the spherical head 11 of the connecting pin 5′ protrudes into the central recess 19 and is in engagement there with the clamping pins 7′. The coupling and decoupling mechanisms operate in a similar manner to the first embodiment described with reference to FIG. 1 of the retention device 1 according to the invention.

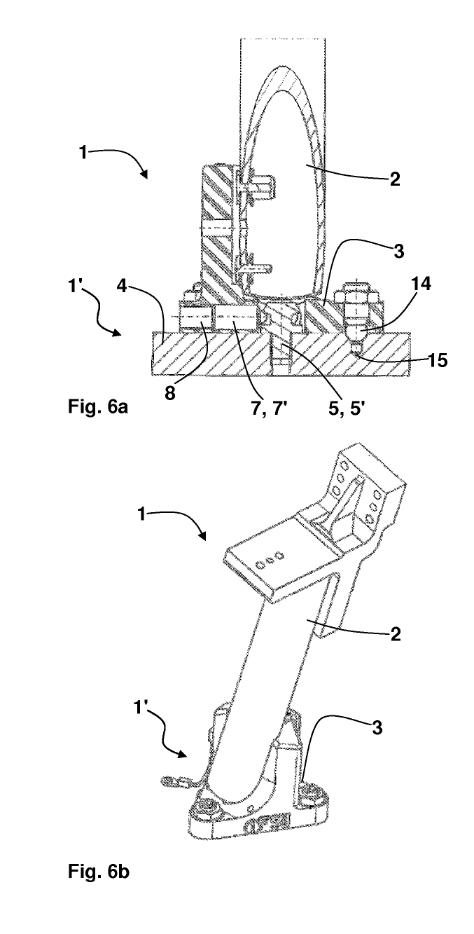

In FIG. 4, a schematic side view of a second coupling unit 4 of a retention device 1 according to the exemplary second embodiment of the present invention is shown, wherein the connecting pin 5′ is also shown for illustrative purposes. The second coupling unit 4 illustrated in FIG. 4 is substantially similar to the second coupling unit shown in FIG. 2a of the retention device 1 according to the first embodiment, wherein the clamping pins 7′ protrude into the central recess 19.

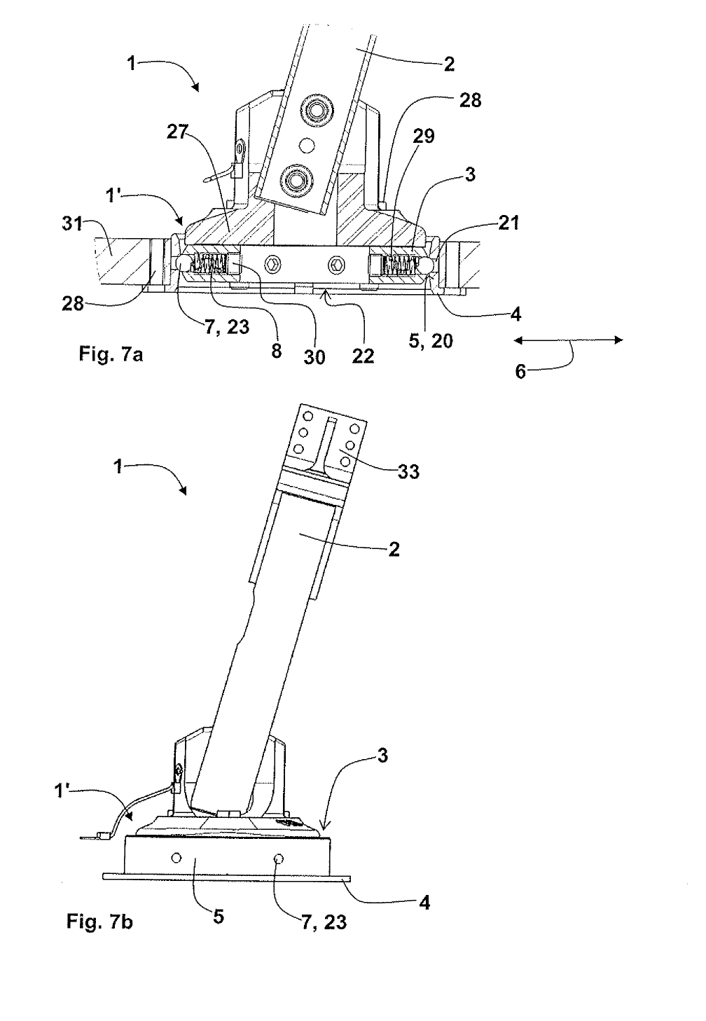

In FIGS. 5a, 5b, 5c schematic views of a retention device 1 according to an exemplary third embodiment of the present invention are shown, wherein the third embodiment is substantially the same as the second embodiment illustrated in FIG. 3, wherein the bottom surfaces of the first and second coupling units 3, 4 are not triangular but of substantially round configuration. In FIG. 5a, a sectional view is shown of the retention device 1 in the coupled position, whilst in FIG. 5c a perspective view is shown of the retention device 1 in the coupled view. In FIG. 5b a schematic exploded view of the retention device 1 is illustrated. The part 2 to be retained is in each case fastened by means of screw connections to the first coupling unit 3.

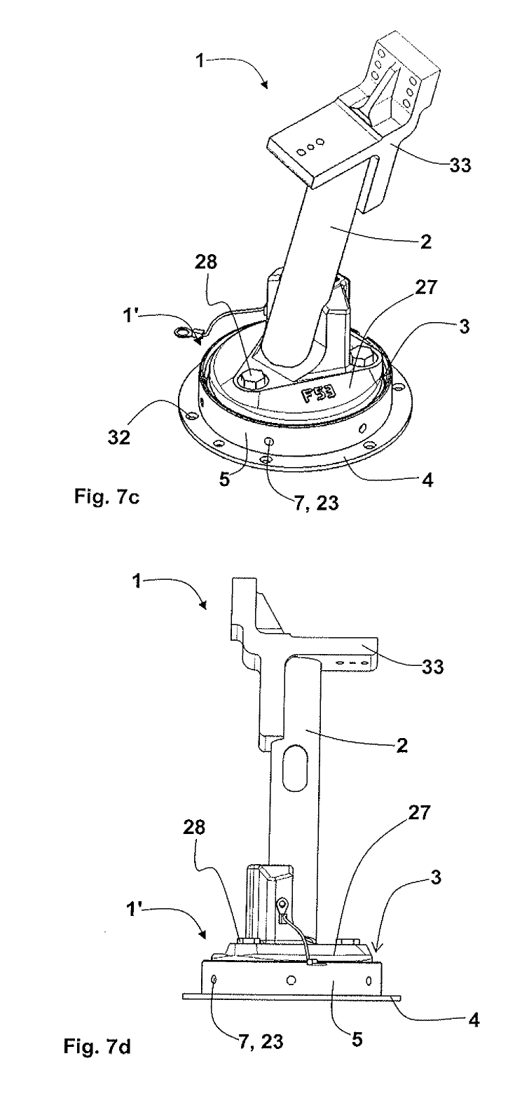

In FIGS. 6a, 6b schematic views of a retention device 1 according to an exemplary fourth embodiment of the present invention are shown, wherein the fourth embodiment substantially equates to the first embodiment illustrated in FIG. 1. The coupling elements 14 in the present example are configured as spherical elements. In FIG. 6a, a sectional view and in FIG. 6b a perspective view of the retention device 1 are shown in each case in the coupled position.

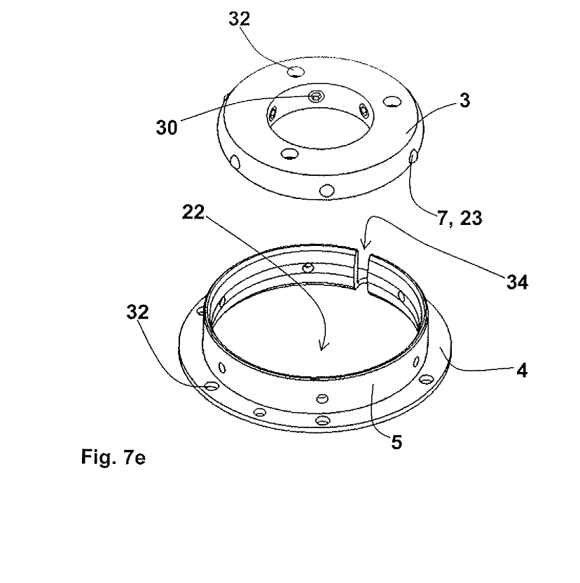

In FIGS. 7a to 7e, schematic views of a retention device 1 according to an exemplary fifth embodiment of the present invention are shown. The retention device 1 has an overload protection coupling 1′ for the retention of at least one part 2 to be retained, said overload protection coupling having a first coupling unit 3 and a second coupling unit 4. The overload protection coupling 1′ is provided during normal operation to ensure a coupling between the first and the second coupling units 3, 4, and to release the coupling automatically in the event of a force acting between the first and the second coupling unit 3, 4 which exceeds a defined limit value (overload).

In FIGS. 7a, 7b, 7c and 7b the retention device 1 is illustrated in each case in a state in which the first and the second coupling units 3, 4 are coupled together. The second coupling unit 4 is fixedly screwed to a retention plate 31, for example by means of fastening screws 28, whilst the first coupling unit 3 is configured for the retention of the part 2 to be retained. In the present example, the part 2 to be retained comprises by way of example a bracket for receiving tools and/or vehicle body components (not illustrated). The retention device 1 is provided for use in vehicle body manufacturing systems in which tools for machining the vehicle body or chassis parts for constructing a vehicle body are retained by means of the bracket.

The bracket comprises a bracket foot 27 and a tube screwed to the bracket foot, said tube bearing a bracket head 33. The bracket foot 27 is fixedly connected by means of three fastening screws 28 to the first coupling unit 3. The first coupling unit 3 is configured as a disc-shaped ring. A plurality of radial bores 29 are formed in the ring. In each of the bores 29, a clamping element 7 configured as a ball 23 is arranged as well as an element 8 configured as a compression spring. An end region of the compression spring is supported in each case on a grub screw 30, whilst the other end region resiliently pretensions the ball 23 in the radial direction outwardly. By means of the grub screw 30, in each case the spring tension may be steplessly adjusted. The second coupling unit 4 has a through-opening 22, a collar functioning as a connecting element 5 protruding from the edge region thereof perpendicular to the main plane 6 in the direction of the bracket. The collar forms a wall 20 of the through-opening 22 and has a plurality of latching openings 21. The maximum external diameter of the through-opening 22 in this case is greater than the maximum external diameter of the first coupling unit 3, so that the first coupling unit 3 is able to move through the through-opening 22 in a direction perpendicular to the main plane 6. In the illustrated coupled state, the first coupling element 3 is located in the same plane as the second coupling unit 4 so that the first coupling unit 3 is at least partially enclosed by the second coupling unit 4 in the main plane 6. The latching openings 21 are distributed on the collar in the peripheral direction such that one respective ball 23 partially protrudes into just one latching opening 21. The balls 23 have a maximum external diameter which is greater than the maximum internal diameter of the latching openings 21, so that the balls 23 are not able to slip through the latching openings 21. Due to the compression springs, the balls 23 are resiliently pretensioned in the latching openings 21, so that the first coupling unit 3 is fixed in a non-positive and positive manner in the second coupling unit 4. The clamping force is in this case determined by the spring forces of the individual compression springs, adjustable by means of the grub screws 30. If a force now acts parallel and/or perpendicular to the main plane 6 onto the part 2 to be retained, the first coupling unit 3 is moved relative to the second coupling unit 4. If the force reaches a predefined release force which exceeds the clamping force, the compression springs are at least partially compressed and at least some of the balls 23 slip out of the latching openings 21. The non-positive and positive connection between the first and second coupling units 3, 4 is as a result released and the first coupling unit 3 automatically released. In this manner it is ensured that in the case of overload no damage is sustained by the retention device 1, by the components to be retained and/or by a robot retaining the retention device 1. The maximum external diameter of the first coupling unit 3 in this case is smaller than the maximum internal diameter of the through-opening 22, so that with an overload acting on the part to be retained perpendicular to the main plane 6 in the direction of the bracket foot 27, the coupling between the first and the second coupling units 3, 4 is released and the first bracket unit 3 is pressed through the through-opening 22 in the second bracket unit 4. The wall 20 of the second coupling unit 4 is bulged in a convex manner on a side facing the first coupling unit 3, whilst the first coupling unit 3 is of convex configuration on a side facing the wall 20. In this manner, a pivoting movement of the first coupling unit 3 relative to the second coupling unit 4 is also permitted, in particular about a pivot axis parallel to the main plane 6, without the first coupling unit 3 being jammed relative to the wall 20. Advantageously, the part to be retained in the event of overload may thus deviate in any direction. The overload protection coupling is released, in particular when forces act on the part 2 to be retained, parallel and/or perpendicular to the main plane 6, which exceed a value predetermined by the adjustable clamping force. Alternatively, naturally it is also conceivable that the balls are configured as clamping pins arranged in the bores 29, which on a side facing the collar have a contact surface 24 of spherical configuration.

In FIG. 6e, the first and the second coupling unit 3, 4 are shown in a perspective detailed view. The first and second coupling units 3, 4 also have fastening bores 32 for receiving fastening screws 28. The second fastening unit 4 has, in particular, a radial slot 34 which facilitates a (further) arrangement of the first fastening unit 3 inside the second fastening unit 4, for example after releasing the overload protection.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

### LIST OF REFERENCE NUMERALS

1 Retention device
1′ Overload protection
2 Part to be retained
3 First coupling unit
4 Second coupling unit
5 Connecting element
5′ Connecting pin
6 Main plane
7 Clamping element
7′ Clamping pin
8 Element
9 Angle
10 Coupling region
11 Spherical head
12 First contact surface
13 Second contact surface
14 Coupling element
15 Counter-coupling element
16 Torque
17 Deflection force
18 Displaceability
19 Recess
20 Wall
21 Latching opening
22 Through-opening
23 Ball
24 Contact surface
27 Bracket foot
28 Fastening screws
29 Bores
30 Grub screws
31 Retention plate
32 Fastening bores
33 Bracket head
34 Slot

What is claimed is:

1. A retention device for the retention of at least one part to be retained in a vehicle body manufacturing system, the retention device comprising:
a) an overload protection coupling, the overload protection coupling having a first and a second coupling unit, and one of the first and second coupling units has a connecting element, which is able to be releasably coupled to the other one of the first and second coupling units; and
b) the other one of the first and second coupling units having at least one clamping element, to which a resilient element is dedicated for producing a clamping force which creates a connection between the clamping element and the connecting element, such that the connection is able to be automatically released by a release force which overcomes the clamping force.

2. Retention device according to claim 1, wherein:
a) the at least one clamping element includes at least three clamping elements; and
b) the second coupling unit includes at least three clamping elements arranged radially in a main plane, and which are arranged substantially rotationally symmetrically around the connecting element aligned perpendicular to the main plane.

3. Retention device according to claim 1, wherein:
a) the at least one clamping element is resiliently pretensioned by the resilient element in the direction of the connecting element, wherein the resilient element preferably comprises an energy storage device for subjecting the at least one clamping element to a force in the direction of the connecting element; and
b) and a device is provided for adjusting the force of the energy storage device acting in the direction of the connecting element.

4. Retention device according to claim 2, wherein:
a) the at least three clamping elements are each arranged offset to one another in the main plane by an angle of 120 degrees, and/or the at least three clamping elements each have a tapering tip on a side facing the connecting element, and/or the at least three clamping elements are each displaceably mounted in the radial direction.

5. Retention device according to claim 1, wherein:
a) the connecting element has a cross-sectional alteration in a coupling region;
b) wherein the at least one clamping element in the coupling region acts positively and/or non-positively on the connecting element; and
c) the connecting element in the coupling region has a spherical head, the at least one clamping element acting on a spherical surface thereof.

6. Retention device according to claim 5, wherein:
a) for adjusting the release force the relative position between the coupling region and the at least one clamping element is able to be adjusted in a direction perpendicular to the main plane.

7. Retention device according to claim 1, wherein:
a) the first coupling unit has a first contact surface parallel to a main plane and the second coupling unit has a second contact surface substantially parallel to the first contact surface, and the first and second contact surfaces bear at least partially against one another.

8. Retention device according to claim 1, wherein:
a) one of the first and second coupling units has at least one coupling element and the other one of the first and second coupling units has at least one complementary counter-coupling element, and the coupling element and the counter-coupling element engage positively in one another perpendicular to the main plane.

9. Retention device according to claim 8, wherein:
a) at least three coupling elements are arranged in the main plane antisymmetrically around the connecting element.

10. Retention device according to claim 1, wherein:
a) the second coupling unit has a through-opening; and
b) the connecting element has a wall extending along an edge region of the through-opening, which has at least one latching opening, with which the clamping element interacts to produce the clamping force effecting the connection between the clamping element and the connecting element, such that the connection is able to be automatically released by a release force overcoming the clamping force.

11. Retention device according to claim 10, wherein:
a) the first coupling unit is at least partially enclosed along a main plane by a wall, and the wall is bulged in a convex manner on a side facing the first coupling unit and/or the first coupling unit is bulged in a convex manner on a side facing the wall.

12. Retention device according to claim 10, wherein:
a) a maximum external diameter of the first coupling unit is smaller than a maximum internal diameter of the through-opening.

13. Retention device according to claim 11, wherein:
a) the wall is configured as a collar which protrudes from the second coupling unit in an edge region of the through-opening in a direction perpendicular to the main plane and/or that the first coupling unit is of annular configuration.

14. Retention device according to claim 10, wherein:
a) the clamping element on a side facing the connecting element, has a contact surface configured as a spherical surface, which is subjected to a force by means of the element in the direction of a latching opening, and the contact surface protrudes at least partially into the latching opening; and
b) the clamping element is configured as a ball, a maximum external diameter thereof being greater than a maximum internal diameter of the latching opening.

15. Use of a retention device according to claim 1, wherein:
a) the retention of at least one part to be retained is in a vehicle body manufacturing system.

16. Use of a retention device according to claim 1, wherein:
a) the retention of at least one part to be retained is in a vehicle body production line.
